(19) United States
(12) Patent Application Publication
(10) Pub. No.: US 2013/0175744 A1
(43) Pub. Date: Jul. 11, 2013

(54) ANTIVIBRATION RUBBER DEVICE

(71) Applicants: Yasuhiro Goshima, Wako-shi (JP); Toshimichi Watanabe, Wako-shi (JP); Teruyuki Hirokawa, Fujimino-city (JP); Jun Aizawa, Fujimino-city (JP)

(72) Inventors: Yasuhiro Goshima, Wako-shi (JP); Toshimichi Watanabe, Wako-shi (JP); Teruyuki Hirokawa, Fujimino-city (JP); Jun Aizawa, Fujimino-city (JP)

(73) Assignees: Yamashita Rubber Co., Ltd., Fujimino-city (JP); Honda Motor Co., Ltd., Tokyo (JP)

(21) Appl. No.: 13/821,119

(22) PCT Filed: Sep. 5, 2011
(86) PCT No.: PCT/JP2011/070169

§ 371 Date: Mar. 25, 2013

(30) Foreign Application Priority Data
Sep. 10, 2010 (JP) 2010-202827

(51) Int. Cl. F16F 1/36; B60K 5/12; F16F 13/10; F16F 15/02

(52) U.S. Cl. CPC F16F 1/36; F16F 15/022; B60K 5/12; F16F 1/3605; F16F 13/10
USPC 267/140.13; 267/141

(57) ABSTRACT

Antivibration rubber device provided between a vibration source and a vehicle body is provided with: a first mounting member (11) which is mounted to the vibration source side; an elastic member (13) which is in close contact with a surface of the first mounting member (11) and has a step formed at the end part on the vibration source side; and a second mounting member (12) which is integrally connected to the vehicle body side, thereby suppressing occurrence of a crack in the elastic member of the antivibration rubber device and improving durability enabling long-term use.

### TECHNICAL FIELD

The present invention relates to an antivibration rubber device.

### BACKGROUND ART

To an engine mount or the like of an automobile, antivibration performance is applied in order to reduce vibration and noise of an engine. For example, Patent Document 1 describes a liquid-sealed type antivibration rubber device in which a vibration-source side mounting member mounted to an engine side, a vehicle body-side mounting member, a liquid-sealed area enclosed by an elastic member made of a rubber material and a diaphragm attached to the vehicle body-side mounting member, a separating member that separates the liquid-sealed area into a main liquid area and a sub liquid area, and an orifice that communicates the main liquid area and the sub liquid are provided.

### CITATION LIST

### Patent Literature

Patent Document 1: Japanese Patent Application Laid-Open Publication No. 2006-090388

### SUMMARY OF INVENTION

### Technical Problem

A constant load is often applied to a part of an elastic member made of a rubber material in an antivibration rubber device, and the part is often exposed to high temperatures over a long period in a state where the part is repeatedly deformed due to vibrations of an engine. Accordingly, a crack tends to occur on the surface of the elastic member (buckling part).

Moreover, by long-term use under high temperatures, it is considered that a possibility of occurrence of a crack of the elastic member is increased near an adhesive interface between the engine-side mounting member and the elastic member.

An object of the present invention is to suppress occurrence of a crack in the elastic member of the antivibration rubber device and to improve durability that enables a long-term use.

### Solution to Problem

According to the present invention, items (1) to (12) described below are provided.

(1) An antivibration rubber device provided between a vibration source and a vehicle body is provided with: a first mounting member that is mounted to the vibration source side; an elastic member that is in close contact with a surface of the first mounting member and that has a step at an end part on the vibration source side; and a second mounting member that is integrally connected to the first mounting member via the elastic member and that is mounted to the vehicle body side.

(2) In the antivibration rubber device according to aforementioned item (1), the step of the elastic member is formed along an outer periphery of an end part of the first mounting member on the vibration source side.

(3) In the antivibration rubber device according to any one of aforementioned items (1) and (2), the step of the elastic member is continuously formed along an outer periphery of the end part of the first mounting member on the vibration source side.

(4) In the antivibration rubber device according to any one of aforementioned items (1) to (3), a surface of the first mounting member is exposed at a part where the step of the elastic member is formed.

(5) In the antivibration rubber device according to any one of aforementioned items (1) to (4), the first mounting member has a main body and a flange part that extends from an outer end part of the main body.

(6) In the antivibration rubber device according to aforementioned item (5), the elastic member is formed to cover a part of a lower surface of the flange part of the first mounting member and a surface of the main body that is continuous to the lower surface.

(7) In the antivibration rubber device according to any one of aforementioned items (1) to (6), the elastic member is composed of a vulcanized rubber obtained by vulcanizing a rubber composition containing chloroprene rubber.

(8) In the antivibration rubber device according to aforementioned item (7), the vulcanized rubber is obtained by vulcanizing a rubber composition containing xanthogen-modified chloroprene rubber and carbon black having a particle size of 400 nm to 600 nm and DBP oil absorption of 20 ml/100 g to 60 ml/100 g.

(9) The antivibration rubber device according to any one of aforementioned items (1) to (8) is further provided with: a liquid-sealed area that is a closed space enclosed by the elastic member and a diaphragm that is mounted on the second mounting member so as to be opposed to the elastic member. A separating member that separates the liquid-sealed area into a main liquid area on the elastic member side and a sub liquid area on the diaphragm side, and an orifice that communicates the main liquid area and the sub liquid area are provided therein.

(10) An antivibration rubber device provided between a vibration source and a vehicle body is provided with: a first mounting member that has a main body mounted to the vibration source side, and a flange part extending from an outer end part of the main body; a second mounting member that is mounted to the vehicle body side; and an elastic member that elastically connects the first mounting member and the second mounting member, and that is in close contact with a surface of the main body so as to expose a lower surface of the flange part of the first mounting member.

(11) In the antivibration rubber device according to aforementioned item (10), the elastic member is in close contact with the first mounting member so as to cover a surface of the main body continuous to the lower surface of the flange part of the first mounting member.

(12) In the antivibration rubber device according to any one of aforementioned items (10) and (11), the elastic member is composed of a vulcanized rubber obtained by vulcanizing a rubber composition containing xanthogen-modified chloroprene rubber and carbon black having a particle size of 400 nm to 600 nm and DBP oil absorption of 20 ml/100 g to 60 ml/100 g by injection molding.

### Advantageous Effects of Invention

According to the present invention, it is possible to suppress occurrence of a crack in the buckling part in the elastic member of the antivibration rubber device, and thus to improve durability enabling long-term use.

Moreover, by covering a part of a gap provided between a first mounting member as the engine-side mounting member and the elastic member with a rubber material, it is possible to suppress the possibility of occurrence of a crack in the elastic member near the adhesive interface between the first mounting member and the elastic member.

### BRIEF DESCRIPTION OF DRAWINGS

FIG. 1 is a view for illustrating a liquid-sealed mount as an example of an antivibration rubber device; and

FIGS. 2A and 2B are views for illustrating the gap between the first mounting member and the elastic member.

### DESCRIPTION OF EMBODIMENTS

Hereinafter, modes for embodying the present invention will be described (hereinafter, exemplary embodiments). It should be noted that the present invention is not limited to the following exemplary embodiments, but may be practiced as various modifications within the scope of the gist of the invention. In addition, drawings are only used for the description of the exemplary embodiments, and do not show actual dimensions.

### <Antivibration Rubber Device>

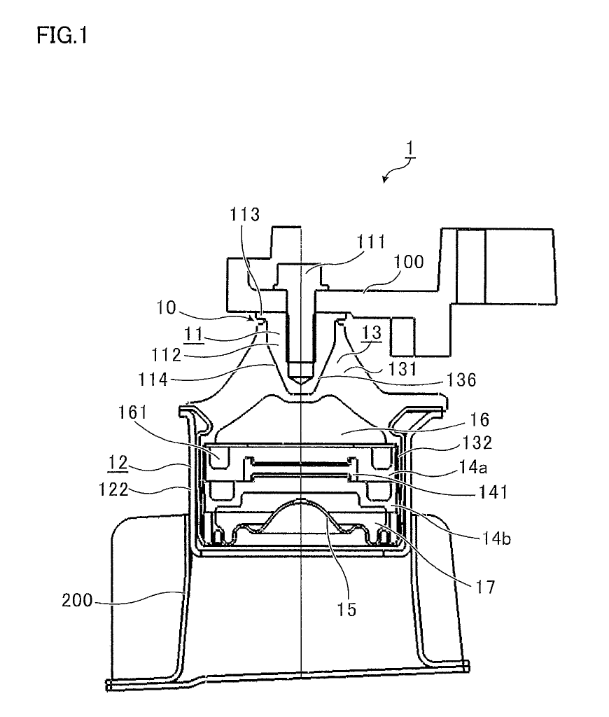

FIG. 1 is a view for illustrating a liquid-sealed mount 1 as an example of an antivibration rubber device. The liquid-sealed mount 1 is provided with a first mounting member 11, a second mounting member 12 and an elastic member 13 that connects the first mounting member 11 and the second mounting member 12 and is integrally equipped with them. The first mounting member 11 is mounted on an engine-side bracket 100 on an engine side for an automobile (not shown) as a vibration source. The second mounting member 12 is mounted on a vehicle body-side bracket 200.

The first mounting member 11 has a main body 112 mounted to the vibration-source side and a flange part 113 extending from the outer end part of the main body 112. The shape of the main body 112 is like a shaft that is in parallel to an entering direction X of a main vibration and that extends toward the inside of the second mounting member 12.

The main body 112 of the first mounting member 11 is engaged with an end of the engine-side bracket 100, and is mounted thereon by a mounting bolt 111. The other end of the engine-side bracket 100 is mounted on an engine not shown in the drawing by a bolt or the like.

The elastic member 13 is configured by a cone part 131 that is formed into a cone-like shape, and a tubular part 132 that is formed into a tube. An inner surface 136 of the cone part 131 is in close contact with a surface 114 of the maim body 112 of the first mounting member 11 by an adhesive agent. The tubular part 132 is integrally formed with the cone part 131, and an outer surface thereof is in close contact with a surface of the second mounting member 12.

In the exemplary embodiment, as shown in FIG. 1, a step that changes the thickness of the cone part 131 is formed at the end part of the elastic member 13 on the engine-side bracket 100 side, and thereby a gap 10 is provided between the elastic member 13 and the flange part 113 of the first mounting member 11. In the gap 10, the lower surface of the flange part 113 and a part of the surface 114 of the main body 112 continuous to the lower surface are exposed. The gap 10 will be described later. Moreover, in the exemplary embodiment, the elastic member 13 is formed of a rubber material containing a natural rubber. The rubber material will be described later.

The second mounting member 12 has a cylindrical part 122 that is in close contact with the outer surface of the tubular part 132 of the elastic member 13.

In the inside of the cylindrical part 122 of the second mounting member 12, a first separating member 14a and a second separating member 14b that are horizontally provided are stacked in two tiers. An elastic film (membrane) 141 is attached to the inside of the first separating member 14a as the upper part. A diaphragm 15 is provided below the second separating member 14b.

In the inside of the elastic member 13, an operating fluid composed of a publicly-known incompressible liquid is sealed, and a main liquid area 16 separated by the inner surface of the elastic member 13 and the first separating member 14a and a sub liquid area 17 separated by the second separating member 14b and the diaphragm 15 are formed. The main liquid area 16 and the sub liquid area 17 communicate with each other by an orifice 161 formed at peripheral end parts of the first separating member 14a and the second separating member 14b.

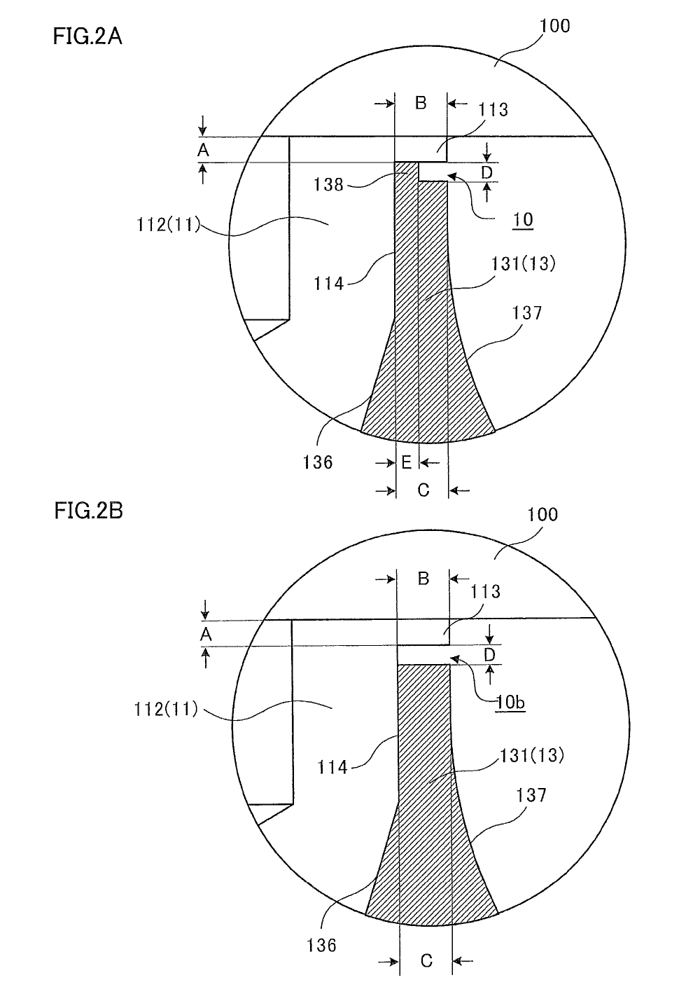

FIGS. 2A and 2B are views for illustrating the gap 10 between the first mounting member 11 and the elastic member 13. FIG. 2A is an enlarged cross-sectional view of a part as the gap 10 of the liquid-sealed mount 1. FIG. 2B is an enlarged cross-sectional view of a gap 10b in another exemplary embodiment.

As shown in FIG. 2A, at an end part 138 of the elastic member 13 on the engine-side bracket 100 side, a step that changes the thickness (C) of the cone part 131 is formed. Thus, the gap 10 is provided between the elastic member 13 and the flange part 113 (thickness A) of the first mounting member 11. The step is continuously formed along the outer circumference of the cone part 131 of the elastic member 13 although it is not shown. Further, in the exemplary embodiment, in the gap 10 where the step is formed, the end part 138 of the elastic member 13 is formed on the main body 112 side of the first mounting member 11. By forming the end part 138, a part of the lower surface of the flange part 113 is covered by the elastic member 13, and the part of the surface 114 of the main body 112 which is continuous to the lower surface of the flange part 113 is covered with the elastic member 13 by the width that is the same as the interval D of the gap 10. Thereby the inner surface 136 of the cone part 131 of the elastic member 13 is in close contact with the entire surface 114 of the main body 112 of the first mounting member 11 so as to cover it. Note that, in the exemplary embodiment, the width E of the end part 138 is within the range of 1 mm to 3 mm.

FIG. 2B shows a shape of the gap 10b in the second exemplary embodiment. The same reference numerals are used for the same configurations as those of the first exemplary embodiment in FIG. 2A, and the description thereof will be omitted.

As shown in FIG. 2B, by forming the step that changes the thickness of the end part of the elastic member 13 on the engine-side bracket 100 side, the gap 10b is provided between the elastic member 13 and the flange part 113. The elastic member 13 is in close contact with the main body 112 of the first mounting member 11 with the gap 10b having the predetermined interval D such that the upper portion of the cone part 131 and the lower surface of the flange part 113 of the first mounting member 11 does not come in contact with each other. The section continuous to the lower surface of the flange part 113 in the surface 114 of the main body 112 of the first mounting member 11 is continuously exposed along the outer circumference of the main body 112 by the width that is the same as the interval D although it is not shown.

In the exemplary embodiment, the thickness C of the section of the elastic member 13 that is in close contact with the main body 112 of the first mounting member 11 at the lower surface of the flange part 113 is within the range of 2 mm to 6 mm. Moreover, the length B of the section of the flange part 113 extending from the main body 112 is equal to or larger than the aforementioned thickness C.

In the exemplary embodiment shown in FIG. 2A, in the case where deformation is repeated, strain of a buckling part 137 of the elastic member 13 is dramatically suppressed and strain of the inner surface 136 of the elastic member 13 is reduced in comparison with the case where the gap 10 is not provided between the flange part 113 and the elastic member 13. Thereby occurrence of a crack at the buckling part 137 is suppressed, a crack occurring in the elastic member 13 near the adhesive interface between the elastic member 13 and the surface 114 of the main body 112 of the first mounting member 11 is suppressed, and durability of the liquid-sealed mount 1 is enhanced.

In the exemplary embodiment shown in FIG. 2B, the elastic member 13 is in close contact with the main body 112 of the first mounting member 11 with the gap 10 having the predetermined interval D so as not to be in contact with the lower surface of the flange part 113 of the first mounting member 11. In the exemplary embodiment, in the case where deformation due to vibration of the engine is repeated, strain of a surface portion of the elastic member 13 is reduced and occurrence of a crack at the buckling part 137 is dramatically suppressed in comparison with the case where the gap 10 is not provided between the flange part 113 and the elastic member 13. Thereby the durability of the liquid-sealed mount 1 is enhanced.

### (Elastic Member 13)

In the exemplary embodiments, a rubber material used for the elastic member 13 of the liquid-sealed mount 1 is arbitrarily selected from rubbers usually used for engine mounts for automobiles, and is not particularly limited. For example, examples thereof include natural rubber (NR), polyisoprene rubber (IR), high cis-polybutadiene rubber (HCBR), low cis-polybutadiene rubber (LCBR), and styrene-butadiene copolymerization rubber (SBR (emulsion polymerized SBR (random), solution polymerized SBR (random styrene-tapered)), and the like. Further, examples thereof include acrylonitrile-butadiene copolymer rubber (NBR), hydrogenated acrylonitrile-butadiene copolymer rubber (HNBR), ethylene-a-olefin-based copolymer rubber (EPR, EPDM), chloroprene rubber and the like.

Among them, natural rubber (NR) is preferable since it has a low motion magnification in comparison with the other rubbers. Here, the motion magnification is a ratio (Kd/Ks) between a static spring constant (Ks (unit: N/mm)) and a dynamic spring constant (Kd (unit: N/mm)) which are measured in accordance with JIS K 6394.

In addition, chloroprene rubber is preferable since it has a tendency to improve weathering resistance when it is used under high temperatures in comparison with a natural rubber (NR) and the like. Chloroprene rubber is not particularly limited since it is obtained by a conventionally well-known polymerization procedure. For example, after chloroprene monomer is emulsion-polymerized in the presence of an organic peroxide such as potassium persulfate under the polymerization temperature that is in the range of 0° C. to 50° C., unreacted chloroprene is removed by a steam stripping method, and chloroprene rubber is obtained through processes such as pH control of the obtained solution, cryocoagulation, washing, hot-air drying and the like.

Further, depending on a type of a molecular weight modifier used at the emulsion polymerization, modified chloroprene rubber that is a mercaptan-modified type, a xanthogen-modified type, or a sulfur-modified type can be obtained. Among the modified chloroprene rubbers, the modified chloroprene rubber that is the xanthogen-modified type is excellent in an antivibration property and durability in comparison with the other modified chloroprene rubbers.

The elastic member 13 in the exemplary embodiments is formed by preparing a rubber composition obtained by containing a various types of strengthening agents, a vulcanizing agent, a vulcanization accelerator, a plasticizing agent, an age inhibitor and the like in the aforementioned rubber material, and vulcanizing the rubber composition.

Examples of the various types of the strengthening agents include carbon black, silica, calcium carbonate, magnesium carbonate, clay, talc, calcium silicate and the like. Among them, carbon black is not particularly limited as long as it is known as a usual strengthening agent for rubbers. For example, furnace black, channel black, thermal black and the like are provided.

In the exemplary embodiments, among carbon blacks as a strengthening agent, it is preferable to contain carbon black having the particle size of 400 nm to 600 nm and DBP oil absorption of 20 ml/100 g to 60 ml/100 g. By containing the carbon black having the particle size within the range, a balance between heat resistance and an antivibration property is preferable. Here, the DBP oil absorption of the carbon black is a value measured by a measurement method in accordance with JIS-K6221 A method, for example.

The used amount of the carbon black is not particularly limited. In the exemplary embodiments, 20 or more parts by weight of the carbon black, or preferably 30 or more parts by weight thereof is contained with respect to 100 parts by weight of a rubber composition. However, in usual, it is used in the range not more than 150 parts by weight, and preferably used in the range not more than 100 parts by weight.

In the case where natural rubber (NR) or the like is used as a rubber material, examples of a vulcanizing agent include a sulfur-based vulcanizing agent, organic peroxide, bismaleimide compound and the like. Examples of the sulfur-based vulcanizing agent include: sulfurs such as powdered sulfur and precipitated sulfur; organic sulfur compound such as 4, 4′-dithiomorpholine, tetramethylthiuram disulfide, tetraethylthiuram disulfide, polymeric polysulfide and the like.

In the case of using the sulfur-based vulcanizing agents, usually, the vulcanization accelerator and a vulcanization accelerating auxiliary are used in combination. Examples of the vulcanization accelerator include a sulfur-containing accelerator of thiuram series, sulfonamide series, thiazole series, dithiocarbamate series, thiourea series and the like; a nitride-containing accelerator of aldehyde-ammonia series, aldehyde-amine series, guanidine series and the like; and the like.

Among the vulcanization accelerators, the thiuram-based accelerator is preferable. Specific examples of the thiuram-based accelerator include tetramethylthiuram disulfide (TT) (TMTD), tetramethylthiuram monosulfide (TS) (TMTM), tetraethylthiuram disulfide (TET) (TETD), tetrabutylthiuram disulfide (TBT) (TBTD), dip entamethylenethiuram hexasulfide (TRA) (DPTT), tetrabenzylthiuram disulfide and the like. Moreover, Examples of the vulcanization accelerating auxiliary include zinc oxide, magnesium oxide and the like. A used amount of each of the vulcanization accelerator and vulcanization accelerating auxiliary is not particularly limited, and is determined in accordance with the type of the sulfur-based vulcanizing agent or the like.

Examples of the organic peroxide include dialkylperoxide, diacylperoxide, peroxyester and the like. Examples of the dialkylperoxide include dicumyl peroxide, di-t-butyl peroxide, 2,5-dimethyl-2,5-di(t-butylperoxy)-3-hexyne, 2,5-dimethyl-2,5-di(t-butylperoxy) hexane, 1,3-bis(t-butylperoxyisopropyl)benzene and the like. Examples of diacylperoxide include benzoyl peroxide, isobutyryl peroxide and the like. Examples of the peroxyester include 2,5-dimethyl-2,5-bis(benzoylperoxy)hexane, t-butylperoxyisopropyl carbonate and the like.

In the case of using the organic peroxide, usually, a crosslinking auxiliary agent is used in combination. Examples of the crosslinking auxiliary agent include triallyl cyanurate, trimethylolpropane trimethacrylate, N,N′-m-phenylenebismaleimide and the like. A used amount of the crosslinking auxiliary agent is not particularly limited, and is determined in accordance with the type of the crosslinking agent or the like.

Examples of the bismaleimide compound includes N,N′-(m-phenylene)bismaleimide, N,N′-(p-phenylene)bismaleimide, N,N′-(o-phenylene)bismaleimide, N,N′-(1,3-naphthylene)bismaleimide, N,N′-(1,4-naphthylene) bismaleimide, N,N′-(1,5-naphthylene)bismaleimide, N,N′-3,3′-dimethyl-4,4′-biphenylene)bismaleimide, N,N′-(3,3′-dichloro-4,4′-biphenylene)bismaleimide and the like.

In the case of using the bismaleimide compound, for example, oximes such as p-quinonedioxime, p,p′-dibenzoyl quinonedioxime, and tetrachloro-p-benzoquinone; morpholine compounds such as 4,4′-dithiodimorpholine, N-ethylmorpholine, and morpholine; and the like are used in combination as necessary.

A contained amount of the sulfur-based vulcanizing agent, organic peroxide or bismaleimide compound is not particularly limited. However, usually, 0.1 parts by weight to 10 parts by weight, preferably 0.3 parts by weight to 7 parts by weight, or more preferably 0.5 parts by weight to 5 parts by weight thereof is contained with respect to 100 parts by weight of the is rubber component.

### (Vulcanized Chloroprene Rubber-Based Composition)

In the case of using chloroprene rubber as a rubber material, a metal oxide is preferable as a vulcanizing agent. Specifically, examples thereof include zinc oxide, magnesium oxide, lead oxide, trilead tetraoxide, iron trioxide, titanium dioxide, calcium oxide and the like. Two or more kinds of them can be used in combination. The additive amount of these metal oxides is usually 3 parts by weight or more, and is preferably 5 parts by weight or more with respect to 100 parts by weight of chloroprene rubber. However, it is usually used in a range not more than 15 parts by weight and preferably used in a range not more than 12 parts by weight.

Examples of a vulcanization accelerator include thiourea-based, guanidine-based, thiuram-based, thiazole-based, triazine-based vulcanization accelerators which are generally used for vulcanization of chloroprene rubber. Among them, the thiourea-based vulcanization accelerator is preferable.

Examples of the thiourea-based vulcanization accelerator include ethylene thiourea, diethyl thiourea, trimethyl thiourea, tryethyl thiourea, N, N′-diphenyl thiourea and the like. Among them, trimethyl thiourea is preferable.

In addition, a vulcanization accelerator composed of a mixture of 3-methylthiazolidine thione-2, thiadiazole and phenylenedimaleimide, dimethyl ammonium hydrogen isophthalate, 1,2-dimercapto-1,3, 4-thiadiazole derivative or the like can be used.

Two or more kinds of these vulcanization accelerators can be used in combination. The additive amount of these vulcanization accelerators is usually 0.2 parts by weight or more and is preferably 0.5 parts by weight or more with respect to 100 parts by weight of chloroprene rubber. However, it is usually used in a range not more than 10 parts by weight, and preferably used in a range not more than 5 parts by weight.

Further, various kinds of medical agents such as extender oil which is processing oil or the like such as aromatic oil, naphthenic oil, paraffinic oil or the like; a plasticizing agent such as dioctyl phthalate; a wax such as a paraffin wax, a carnauba wax or the like; a stabilizing agent; a colorant; and the like can be contained as necessary for the usage.

Further, in the exemplary embodiments, it is preferable that an age inhibitor is contained in the aforementioned rubber composition. Examples of the age inhibitor include an amine-ketone series such as poly-(2,2,4-trimethyl-1,2-dihydroquinone); an amine series such as N-phenyl-N′-isopropyl-p-phenylenediamine, and N-phenyl-N′-(3-methacryloyloxy-2-hydroxypropyl)-p-phenylenediamine; a phenol series such as 2,2′-methylene-bis(4-ethyl-6-t-buthylphenol); 2-mercaptobenzimidazole; and the like. The contained amount of the age inhibitor is not particularly limited; however, it is usually 0.1 parts by weight to 10 parts by weight, preferably 0.3 parts by weight to 7 parts by weight, and more preferably 0.5 parts by weight to 5 parts by weight with respect to 100 parts by weight of a rubber composition.

### (Production Method Of The Elastic Member 13)

In the exemplary embodiments, the aforementioned rubber composition is usually prepared as a vulcanized rubber composition by kneading and mixing the rubber composition, carbon black and if necessary other compounding agents such as another strengthening agent, vulcanizing agent and the like by a mixing machine such as a roller, banbury mixer or the like.

Next, the vulcanized rubber composition in which the aforementioned vulcanizing agent has been contained is formed to be a predetermined shape by a conventionally well-known forming method such as injection molding, extrusion molding or the like, and is vulcanized by a method such as steam vulcanization.

The vulcanizing temperature of the vulcanized rubber composition is not particularly limited; however, it is usually 100° C. to 200° C., preferably 130° C. to 190° C., and more preferably 140° C. to 180° C. In addition, the vulcanizing time is changed as necessary depending on the vulcanization method, temperature, shape and the like, and it is not particularly limited; however, it is usually 1 minute or more, and 5 hours or less. Note that, as necessary, secondary vulcanization can be conducted. In the case of conducting the secondary vulcanization, for example, it is preferable that the primary vulcanization is conducted under about 160° C. for around 95 minutes, and then the secondary vulcanization is conducted under about 150° C. for around 2 hours.

The vulcanization method can be selected from techniques usually used for vulcanization of rubber, such as press heating, steam heating, oven heating and hot air heating.

In the exemplary embodiments, if the elastic member 13 formed by using a vulcanized rubber composition containing chloroprene rubber is used, durability as an antivibration rubber device is further improved in comparison with the case where chloroprene rubber is not used. In particular, among chloroprene rubber, the modified chloroprene rubber that is a xanthogen-modified type suppresses a crack at the buckling part 137 of the elastic member 13, and further, has a large suppressing effect on peeling at the adhesive interface between the first mounting member 11 and the inner surface 136 of the elastic member 13, and thus a crack occurring in the elastic member 13 near the adhesive interface is suppressed.

As a vulcanized rubber composition including chloroprene rubber, 20 parts by weight to 100 parts by weight of the carbon black that has the particle size of 400 nm to 600 nm and DBP oil absorption of 20 ml/100 g to 60 ml/100 g is preferably contained with respect to 100 parts by weight of the modified chloroprene rubber that is a xanthogen-modified type.

In the exemplary embodiments, the elastic member 13 is adhered to the first mounting member 11 and the second mounting member 12 by an adhesive agent. Thereby the first mounting member 11 and the second mounting member 12 are integrally connected to each other via the elastic member 13. The adhesive agent to be used is not particularly limited.

The antivibration rubber device to which the exemplary embodiments are applied is usable as a various kinds of antivibration rubber devices for automobiles such as an engine mount, a body mount, a cab mount, a member mount, a strut-bar cushion, a center bearing support, a torsional damper, a steering rubber coupling, a tension-rod bush, a lowering bush, an arm bush, a bump strapper, an FF engine roll stopper, a muffler hanger, and the like.

### EXAMPLES

Hereinbelow, the present invention will be further described in detail on the basis of examples. It should be noted that, the present invention is not limited to the examples. Note that all parts and % in the examples and comparative examples are on a weight basis, except where specifically noted.

### (1) Durability Test Of Liquid-Sealed Mount

In accordance with JIS K6385 (“test procedure for antivibration rubber” 12. Durability test b) constant load durability test), strain at the surface (the buckling part 137) of the elastic member 13 configuring the liquid-sealed mount 1 and the inner surface 136 which is in contact with the main body 112 of the first mounting member 11 was measured (unit: %). The smaller the value is, the better the property as the liquid-sealed mount 1 is.

### (2) Preparation For Elastic Member

The elastic member 13 configuring the liquid-sealed mount 1 for the durability test was prepared by forming the rubber composition having the following composition by injection molding and conducting secondary vulcanization under about 150° C. for around 2 hours after primary vulcanization under about 160° C. for around 9.5 minutes.

### (Composition)

| | | |
|---|---|---|
| Natural rubber | 80 | parts |
| Polybutadiene rubber | 20 | parts |
| Carbon black (FEF) | 15 | parts |
| Stearic acid | 1 | part |
| Zinc oxide | 5 | parts |
| Age inhibitor | 1 | part |
| Sulfur | 1 | part |

### Examples 1 And 2, Comparative Example 1

For the shapes of the elastic member 13 of the liquid-sealed mount 1 as shown in the embodiment (first exemplary embodiment (example 1)) described in the aforementioned FIG. 2A and the embodiment (second exemplary embodiment (example 2)) described in FIG. 2B, strain (%) of the buckling part 137 of the elastic member 13 was measured on the basis of JIS K6385.

In addition, for the embodiment (comparative example 1) in which no gap 10 is provided between the elastic member 13 and the flange part 113 in FIG. 2A, strain (%) of the buckling part 137 of the elastic member 13 was measured for comparison.

As a result, strain (%) of the buckling part 137 was 48.9% in “the first exemplary embodiment (example 1),” and strain (%) of the buckling part 137 was 43.2% in “the second exemplary embodiment (example 2)” under compression of 15.0 mm.

Meanwhile, strain (%) of the buckling part 137 was 71.4% in the case of the embodiment (comparative example 1) in which no gap 10 is provided between the elastic member 13 and the flange part 113.

From these results, it is recognized that occurrence of a clack at the buckling part 137 of the elastic member 13 is suppressed in the liquid-sealed mounts 1 of the first exemplary embodiment (FIG. 2A) and the second exemplary embodiment (FIG. 2B) in comparison with the liquid-sealed mount (comparative example 1) in which no gap 10 is provided.

### Examples 3 And 4

On the basis of JIS K6385, strain (hereinafter, mentioned as “interface strain”) of the inner surface 136 that is in contact with the main body 112 of the first mounting member 11 in each of the liquid-sealed mount used in example 1 (first exemplary embodiment (example 3)) and the liquid-sealed mount used in example 2 (second exemplary embodiment (example 4)) was measured (unit: %).

As a result of the measurement, under compression of 11.3 mm, interface strain (%) of the elastic member 13 was 58.3% in “the first exemplary embodiment (example 3),” and interface strain (%) thereof was 82.7% in “the second exemplary embodiment (example 4).”

Accordingly, it is recognized that, in the case of “the first exemplary embodiment,” interface strain at the inner surface 136 that is in contact with the main body 112 of the first mounting member 11 is further suppressed in the elastic member 13 of the liquid-sealed mount 1 in comparison with “the second exemplary embodiment.” Consequently, reduction effect on peeling at the adhesive interface is increased.

### REFERENCE SIGNS LIST

1 . . . Liquid-sealed mount

### 10, 10b . . . Gap

11 . . . First mounting member
12 . . . Second mounting member
13 . . . Elastic member
14a . . . First separating member
14b . . . Second separating member

### 15 . . . Diaphragm

16 . . . Main liquid area
17 . . . Sub liquid area
100 . . . Engine-side bracket
111 . . . Mounting bolt
112 . . . Main body
113 . . . Flange part

### 114 . . . Surface

122 . . . Cylindrical part
131 . . . Cone part
132 . . . Tubular part
136 . . . Inner surface
137 . . . Buckling part
138 . . . End part
141 . . . Elastic film (membrane)

### 161 . . . Orifice

200 . . . Vehicle body-side bracket

1. An antivibration rubber device provided between a vibration source and a vehicle body, comprising:
a first mounting member that is mounted to the vibration source side;
an elastic member that is in close contact with a surface of the first mounting member and that has a step at an end part on the vibration source side; and
a second mounting member that is integrally connected to the first mounting member via the elastic member and that is mounted to the vehicle body side.

2. The antivibration rubber device according to claim 1, wherein the step of the elastic member is formed along an outer periphery of an end part of the first mounting member on the vibration source side.

3. The antivibration rubber device according to claim 1, wherein the step of the elastic member is continuously formed along an outer periphery of the end part of the first mounting member on the vibration source side.

4. The antivibration rubber device according to claim 1, wherein a surface of the first mounting member is exposed at a part where the step of the elastic member is formed.

5. The antivibration rubber device according to claim 1, wherein the first mounting member has a main body and a flange part that extends from an outer end part of the main body.

6. The antivibration rubber device according to claim 5, wherein the elastic member is formed to cover a part of a lower surface of the flange part of the first mounting member and a surface of the main body that is continuous to the lower surface.

7. The antivibration rubber device according to claim 1, wherein the elastic member is composed of a vulcanized rubber obtained by vulcanizing a rubber composition containing chloroprene rubber.

8. The antivibration rubber device according to claim 7, wherein the vulcanized rubber is obtained by vulcanizing a rubber composition containing xanthogen-modified chloroprene rubber and carbon black having a particle size of 400 nm to 600 nm and DBP oil absorption of 20 ml/100 g to 60 ml/100 g.

9. The antivibration rubber device according to claim 1, further comprising:
a liquid-sealed area that is a closed space enclosed by the elastic member and a diaphragm that is mounted on the second mounting member so as to be opposed to the elastic member, wherein
a separating member that separates the liquid-sealed area into a main liquid area on the elastic member side and a sub liquid area on the diaphragm side, and an orifice that communicates the main liquid area and the sub liquid area are provided therein.

10. An antivibration rubber device provided between a vibration source and a vehicle body, comprising:
a first mounting member that has a main body mounted to the vibration source side, and a flange part extending from an outer end part of the main body;
a second mounting member that is mounted to the vehicle body side; and
an elastic member that elastically connects the first mounting member and the second mounting member, and that is in close contact with a surface of the main body so as to expose a lower surface of the flange part of the first mounting member.

11. The antivibration rubber device according to claim 10, wherein the elastic member is in close contact with the first mounting member so as to cover a surface of the main body continuous to the lower surface of the flange part of the first mounting member.

12. The antivibration rubber device according to claim 10, wherein the elastic member is composed of a vulcanized rubber obtained by vulcanizing a rubber composition containing xanthogen-modified chloroprene rubber and carbon black having a particle size of 400 nm to 600 nm and DBP oil absorption of 20 ml/100 g to 60 ml/100 g by injection molding.
